(19) United States
(12) Patent Application Publication
(10) Pub. No.: US 2020/0308431 A1
(43) Pub. Date: Oct. 1, 2020

(54) AQUEOUS INK JET COMPOSITION, METHOD FOR PRODUCING AQUEOUS INK JET COMPOSITION, AND METHOD FOR PRODUCING RECORDING

(71) Applicant: Seiko Epson Corporation, Tokyo (JP)

(72) Inventors: Soichi YAMAZAKI, Shiojiri (JP); Naoyuki TOYODA, Suwa (JP); Hiroaki KUMETA, Matsumoto (JP); Shunsuke UCHIZONO, Shiojiri (JP); Manabu TANIGUCHI, Shiojiri (JP)

(21) Appl. No.: 16/830,434

(22) Filed: Mar. 26, 2020

(30) Foreign Application Priority Data
Mar. 27, 2019 (JP) 2019-060137

(51) Int. Cl. C09D 11/328; D06P 5/20; D06P 5/30; D06P 5/28

(52) U.S. Cl. CPC C09D 11/328; D06P 5/2077; C08L 67/00; D06P 5/006; D06P 5/30

(57) ABSTRACT

An aqueous ink jet composition contains water and particles of a material containing polyester and a dye composed of at least one of sublimation dyes or at least one of disperse dyes. Preferably, the dye is dispersed in the particles.

The present application is based on, and claims priority from JP Application Serial Number 2019-060137, filed Mar. 27, 2019, the disclosure of which is hereby incorporated by reference herein in its entirety.

### BACKGROUND

### 1. Technical Field

The present disclosure relates to an aqueous ink jet composition, a method for producing an aqueous ink jet composition, and a method for producing a recording.

### 2. Related Art

In recent years, ink jet printing is becoming more widely used. Besides business and home printers, the technology is now applied to areas such as commercial printing and textile printing.

Against this background, certain types of inks currently used for ink jet printing contain a sublimation dye, i.e., a dye that can sublime, or a disperse dye.

Examples of printing processes in which such ink jet inks are used include direct printing, in which inks are attached to the recording medium to be dyed and then the dyes are fixed by heating, such as steaming, and thermal-transfer printing, in which dye inks are attached to an intermediate transfer medium and then heat is applied to transfer, by sublimation, the dyes from the intermediate transfer medium to the recording medium to be dyed (e.g., see JP-A-10-58638).

Producing strong colors in such settings requires a polyester surface on the recording medium, and this has limited the range of recording media that can be used. Increasing the heating temperature can improve the strength of the colors produced by the sublimation or disperse dyes, but depending on the type of recording medium, it can cause an unwanted discoloration, for example by causing the recording medium itself to melt or scorch.

### SUMMARY

The present disclosure was made to solve the above problem and can be implemented as in the following exemplary applications.

An aqueous ink jet composition according to an exemplary application of the present disclosure contains water and particles of a material containing polyester and a dye composed of at least one of sublimation dyes or at least one of disperse dyes.

In an aqueous ink jet composition according to another exemplary application of the present disclosure, the dye is dispersed in the particles.

In an aqueous ink jet composition according to another exemplary application of the present disclosure, 4≤X_{P}/X_{D≤}300, where X_{D} is the percentage of the dye in the particles in % by mass, and X_{P} is the percentage of the polyester in the particles in % by mass.

In an aqueous ink jet composition according to another exemplary application of the present disclosure, the average diameter of the particles is 100 nm or more and 300 nm or less.

In an aqueous ink jet composition according to another exemplary application of the present disclosure, the dye is C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, or C.I. Disperse Yellow 232.

In an aqueous ink jet composition according to another exemplary application of the present disclosure, the polyester is a self-emulsifying polyester.

A method according to an exemplary application of the present disclosure for producing an aqueous ink jet composition includes an emulsion preparation step, in which an emulsion is prepared by mixing a first composition and a second composition together, the first composition containing polyester, an organic solvent, and a dye composed of at least one of sublimation dyes or at least one of disperse dyes and the second composition containing water, and thereby inducing phase inversion emulsification of the first composition; and an organic solvent removal step, in which at least part of the organic solvent is removed from the emulsion.

A method according to an exemplary application of the present disclosure for producing a recording includes an attachment step, in which an aqueous ink jet composition according to an exemplary application of the present disclosure is ejected by ink jet technology and attached to a recording medium; and a heating step, in which the recording medium with the aqueous ink jet composition attached thereto is heated.

In a method according to another exemplary application of the present disclosure for producing a recording, the recording medium is a piece of fabric.

In a method according to another exemplary application of the present disclosure for producing a recording, the recording medium is made of at least one material including one or two or more selected from the group consisting of silk, wool, cellulose, acrylic fiber, polyurethane, and polyamide.

In a method according to another exemplary application of the present disclosure for producing a recording, the recording medium is made of materials including polyester and one or two or more selected from the group consisting of cotton, silk, polyamide, acrylic fiber, and polyurethane.

In a method according to another exemplary application of the present disclosure for producing a recording, the temperature at which the recording medium is heated in the heating step is 100° C. or more and 160° C. or less.

### DESCRIPTION OF EXEMPLARY EMBODIMENTS

The following describes preferred embodiments of the present disclosure in detail.

### Aqueous Ink Jet Composition

First, an aqueous ink jet composition according to a preferred embodiment of the present disclosure is described.

The aqueous ink jet composition according to a preferred embodiment of the present disclosure contains water and particles of a material that contains polyester and a dye composed of at least one of sublimation dyes or at least one of disperse dyes.

By satisfying these conditions, the aqueous ink jet composition produces a strong color with a wide variety of recording media. Of particular note is that the composition produces a strong color even when the recording medium is heated at a relatively low temperature for a relatively short period of time. The composition is therefore suitable even for use with recording media vulnerable to heat, such as those made of a material that melts or undergoes an unwanted discoloration upon heating at a relatively low temperature, providing more flexibility in the selection of the recording medium. By virtue of being capable of producing a strong color even when the recording medium is heated at a relatively low temperature for a relatively short period of time, the composition is also advantageous in terms of energy conservation and improving productivity in manufacturing recordings. Furthermore, as stated, the dye is present in particles containing polyester. When a recording is produced using the aqueous ink jet composition, this provides good prevention of prevents events like an unwanted detachment of the dye from the recording, thereby ensuring stable retention of the dye by the recording. This means even when the recording is heated, for example by laundering or washing with warm water, heat drying in a dryer, or ironing, an unwanted diffusion of the dye from the recording is prevented effectively. The aqueous ink jet composition according to a preferred embodiment of the present disclosure, moreover, can be used in methods for producing a recording in which no transfer is involved (described in detail later herein) and therefore is also favorable in terms of, for example, improving productivity in manufacturing recordings, reducing the cost of producing recordings, and resource conservation. Besides these, the composition is efficient in color production by the dye. Even when its dye content is low, therefore, the aqueous ink jet composition gives recordings produced therewith a sufficiently high color density.

The inventors believe these great advantages owe to the following reason. That is, whereas heating a sublimation or disperse dye causes it to sublime or diffuse, heating polyester causes it to decompose. Polyester has ester linkages in its backbone, and when it is heated, some of the ester linkages break into carboxyl groups and hydroxyl groups. When the polyester is cooled, the carboxyl and hydroxyl groups recombine together. Heating particles containing both polyester and at least one of sublimation or disperse dyes and then cooling them therefore causes the sublimation or disperse dye to sublime or diffuse as single molecules and then keep its single-molecule state inside the polyester. As a result, the inventors believe, a strong color is produced. Furthermore, since the sublimation or disperse dye becomes single molecules even when its distance of travel is short compared with that in the known transfer by sublimation, the color produced is sufficiently strong even with a relatively short heating at a relatively low temperature.

It should be noted that sublimation and disperse dyes produce strong colors by becoming single molecules. Aggregates of molecules are poor in color strength compared with single molecules, however high the dye content is.

What is crucial for efficient separation of a sublimation or disperse dye into single molecules is that the dye coexists with polyester in the same particles. The inventors found this, and arrived at the present disclosure.

When the above conditions are not satisfied, the results are unsatisfactory.

For example, with a polyester-free aqueous ink jet composition, it would be difficult to increase the percentage of single molecules in all molecules of the sublimation or disperse dye sufficiently high except with a recording medium having a polyester surface. The color strength would therefore be unsatisfactory.

With an aqueous ink jet composition that contains polyester but not in the same particles as the dye (e.g., when a subset of the particles in the composition contains polyester but does not contain the dye, another contains the dye but does not contain polyester, and there are no particles containing both polyester and the dye), too, it would be difficult to increase the percentage of single molecules in all molecules of the sublimation or disperse dye sufficiently high except with a recording medium having a polyester surface. The color strength would therefore be unsatisfactory.

It should be noted that an aqueous ink jet composition herein refers not only to ink itself ejected by ink jet technology but also to undiluted solution from which the ink is prepared. In other words, an aqueous ink jet composition according to a preferred embodiment of the present disclosure may be ejected by ink jet technology directly or may be ejected by ink jet technology after dilution or any such treatment. An aqueous ink jet composition herein, moreover, contains at least water as a major volatile liquid component. The proportion of water to all volatile liquid components in the aqueous ink jet composition is preferably 40% by mass or more, more preferably 50% by mass or more, even more preferably 70% by mass or more.

### Particles

The aqueous ink jet composition according to a preferred embodiment of the present disclosure contains particles of a material that contains polyester and a dye composed of at least one of sublimation dyes or at least one of disperse dyes.

The lower limit to the average diameter of the particles is not critical, but preferably is 100 nm, more preferably 120 nm, even more preferably 140 nm. The upper limit to the average diameter of the particles is not critical, but preferably is 300 nm, more preferably 280 nm, even more preferably 260 nm.

This makes it easier to prepare the aqueous ink jet composition. The stability of the particles dispersed in the aqueous ink jet composition will also be bettered, and so will be the storage stability of the aqueous ink jet composition and the stability of the aqueous ink jet composition upon ink jet ejection. After the aqueous ink jet composition is attached to a recording medium, moreover, single molecules of the specific dye (defined below) will adsorb onto the polyester better. As a result, the color produced by the specific dye will be even stronger.

An average diameter of particles herein refers to the volume-average diameter of the particles unless stated otherwise. The average diameter of particles can be determined by, for example, measurement using Microtrac UPA (Nikkiso).

The particles as a component of the aqueous ink jet composition only need to contain a dye as described above and polyester, but the lower limit to X_{P}/X_{D}, where X_{D} is the percentage of the dye in the particles (% by mass), and X_{P} is the polyester content of the particles (% by mass), is preferably 4, more preferably 10, even more preferably 15. The upper limit to X_{P}/X_{D} is preferably 300, more preferably 200, even more preferably 100.

In the manufacture of recordings, this leads to an even higher percentage of single molecules in all molecules of the sublimation or disperse dye in the aqueous ink jet composition attached to a recording medium. The color produced by the dye will therefore be even stronger with a wide variety of recording media. Moreover, when a recording producing using the aqueous ink jet composition is heated, for example by laundering or washing with warm water, heat drying in a dryer, or ironing, an unwanted diffusion of the dye from the recording will be prevented more effectively.

### Specific Dye

The particles as a component of the aqueous ink jet composition according to a preferred embodiment of the present disclosure contain a dye composed of at least one of sublimation dyes or at least one of disperse dyes. The dye composed of at least one of sublimation dyes and disperse dyes may hereinafter be collectively referred to as “specific dyes.”

In general, specific dyes produce strong colors when used with polyester. However, when used with other types of recording media, such as those made of materials like wool, cellulose, cotton, silk, polyester, polyamide, acrylic fiber, and polyurethane, specific dyes only produce weaker colors.

The specific dye only needs to be contained in the particles together with the polyester, but preferably is dispersed in the particles.

This helps achieve better diffusion of the specific dye in the polyester upon heating. The percentage of single molecules in all molecules of the specific dye will therefore be even higher, and even a brief heating can separate the specific dye into single molecules. The manufacturing of recordings using the composition will therefore be further productive, and the color produced by the dye will be even stronger with a wide variety of recording media. Moreover, by virtue of the specific dye in the aqueous ink jet composition being present dispersed in the particles, it is more certain that recordings produced using the aqueous ink jet composition will contain only a small percentage of dye molecules not dispersed in the polyester. As a result, when a recording produced using the aqueous ink jet composition is heated, for example by laundering or washing with warm water, heat drying in a dryer, or ironing, an unwanted diffusion of the dye from the recording will be prevented more effectively.

It is particularly preferred that the specific dye be disseminated in multiple regions in each of the particles.

This makes the aforementioned advantages more significant, presumably for the following reason. That is, when the specific dye is disseminated in multiple regions in each of the particles, the specific dye is finer than otherwise for a given diameter of the particles. The inventors believe this fineness helps the specific dye become single molecules upon heated, thereby improving efficiency in color production.

It should be noted that even when the particles contain the specific dye disseminated, part of the specific dye may be exposed on the surface of the particles.

Examples of sublimation or disperse dyes include C.I. Disperse Yellow 1, 3, 4, 5, 7, 9, 13, 23, 24, 30, 33, 34, 42, 44, 49, 50, 51, 54, 56, 58, 60, 61, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 154, 160, 162, 163, 164, 165, 179, 180, 182, 183, 184, 186, 192, 198, 199, 201, 202, 204, 210, 211, 215, 216, 218, 224, 227, 231, and 232; C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, and 142; C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328, and 364; C.I. Disperse Violet 1, 4, 8, 23, 26, 27, 28, 31, 33, 35, 36, 38, 40, 43, 46, 48, 50, 51, 52, 56, 57, 59, 61, 63, 69, and 77; C.I. Disperse Green 9; C.I. Disperse Brown 1, 2, 4, 9, 13, and 19; C.I. Disperse Blue 3, 7, 9, 14, 16, 19, 20, 24, 26, 27, 35, 43, 44, 54, 55, 56, 58, 60, 62, 64, 71, 72, 73, 75, 79, 81, 82, 83, 87, 91, 92, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333, 359, and 360; C.I. Disperse Black 1, 3, 10, and 24.

Examples of sublimation or disperse fluorescent dyes include C.I. Disperse Red 364, C.I. Disperse Red 362, C.I. Vat Red 41, C.I. Disperse Yellow 232, C.I. Disperse Yellow 184, C.I. Disperse Yellow 82, and C.I. Disperse Yellow 43.

The specific dye may be one such sublimation or disperse dye or may be a combination of two or more.

It is particularly preferred that the specific dye be C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, or C.I. Disperse Yellow 232.

This helps make the color strength of the dye print on a recording even better. The color strength, moreover, will be sufficient even with heating for a shorter duration at a lower temperature.

The lower limit to the specific dye content of the aqueous ink jet composition is preferably 0.05% by mass, more preferably 0.07% by mass, even more preferably 0.1% by mass. The upper limit to the specific dye content of the aqueous ink jet composition is preferably 1% by mass, more preferably 0.7% by mass, even more preferably 0.4% by mass.

This helps achieve even better separation of the specific dye into single molecules in the dye print. The optical density, moreover, will be even higher.

### Polyester

The particles as a component of the aqueous ink jet composition according to a preferred embodiment of the present disclosure contain polyester.

In general, polyesters can be dyed well with specific dyes as defined above.

The polyester can be, for example, polyethylene terephthalate, polybutylene terephthalate, polytrimethylene terephthalate, polyethylene naphthalate, or polybutylene naphthalate.

The polyester can be any polymer material that has the ester linkage in its backbone. Thus, the polyester may be, for example, a modified polyester.

Preferably, the polyester as a component of the particles is a self-emulsifying polyester.

This helps better, for example, the stability of the particles dispersed in the aqueous ink jet composition and the stability of the composition upon ink jet ejection. Of particular note is that the stability of the particles dispersed in the aqueous ink jet composition and the stability of the composition upon ink jet ejection will be good even when the composition is made using no surfactant or emulsifier or using some but only a small amount of surfactant or emulsifier. Furthermore, when the aqueous ink jet composition is manufactured using a method like that detailed below, i.e., a method that includes preparing an emulsion and removing organic solvent(s), the manufacture of the aqueous ink jet composition will be more productive, and the average diameter of the particles can be better adjusted to any of the ranges given above.

Examples of self-emulsifying polyesters include Toagosei's ARON MELT PES-1000 and ARON MELT PES-2000 polyesters, DIC's FINEDIC, and Toyobo's VYLONAL.

The lower limit to the acid value of the polyester is preferably 1.0 KOH mg/g, more preferably 1.5 KOH mg/g, even more preferably 2.0 KOH mg/g. The upper limit to the acid value of the polyester is preferably 15 KOH mg/g, more preferably 10 KOH mg/g, even more preferably 5.0 KOH mg/g.

This helps ensure the specific dye will produce an even stronger color with a wide variety of recording media.

The lower limit to the hydroxyl value of the polyester is preferably 1.0 KOH mg/g, more preferably 2.0 KOH mg/g, even more preferably 3.0 KOH mg/g. The upper limit to the hydroxyl value of the polyester is preferably 20 KOH mg/g, more preferably 15 KOH mg/g, even more preferably 10 KOH mg/g.

This helps ensure the specific dye will produce an even stronger color with a wide variety of recording media.

The lower limit to the number-average molecular weight of the polyester is preferably 3000, more preferably 6000, even more preferably 10000. The upper limit to the number-average molecular weight of the polyester is preferably 25000, more preferably 20000, even more preferably 18000.

This help ensure the specific dye will produce an even stronger color with a wide variety of recording media.

The lower limit to the polyester content of the aqueous ink jet composition is preferably 4% by mass, more preferably 7% by mass, even more preferably 10% by mass. The upper limit to the polyester content of the aqueous ink jet composition is preferably 40% by mass, more preferably 35% by mass, even more preferably 30% by mass.

This helps better the storage stability of the aqueous ink jet composition and the stability of the aqueous ink jet composition upon ink jet ejection. The color strength of the specific dye and the optical density of the dye print, moreover, will be even better.

### Other Ingredients

The particles as a component of the aqueous ink jet composition may contain ingredients other than those described above.

Examples of such ingredients include colorants other than specific dyes; resin materials other than polyesters; dispersants; emulsifiers; water and nonaqueous solvents as described below; surfactants; penetrants, such as triethylene glycol monomethyl ether, triethylene glycol monobutyl ether, diethylene glycol monomethyl ether, 1,2-hexanediol, 1,2-pentanediol, 1,2-butanediol, and 3-methyl-1,5-pentanediol; drying retarders, such as triethanolamine; pH-adjusting agents; chelating agents, such as ethylenediaminetetraacetate; antimolds/preservatives; and antirusts. Compounds having an isothiazolinone structure in the molecule, for example, are suitable for use as antimolds/preservatives.

The amount of ingredients other than the specific dye and polyester in the particles is preferably 6% by mass or less, more preferably 5% by mass or less.

### Water

Besides the particles, the aqueous ink jet composition contains water. The water functions as a dispersion medium for the particles.

The water may be, for example, reverse osmosis (RO) water, distilled water, ion exchange water, or any other type of purified water.

The lower limit to the water content of the aqueous ink jet composition is not critical, but preferably is 30% by mass, more preferably 35% by mass, even more preferably 40% by mass. The upper limit to the water content of the aqueous ink jet composition is not critical, but preferably is 85% by mass, more preferably 80% by mass, even more preferably 75% by mass.

This makes it more certain that the viscosity of the aqueous ink jet composition is adjusted to an appropriate level, thereby helping further improve the stability of the composition upon ink jet ejection.

### Nonaqueous Solvents

Besides the particles and water, the aqueous ink jet composition may contain a nonaqueous solvent.

This helps adjust the viscosity of the aqueous ink jet composition to an appropriate level and also helps improve the water retention of the aqueous ink jet composition. As a result, ink jet ejection of droplets of the composition will be more stable.

Examples of nonaqueous solvents that can be contained in the aqueous ink jet composition include glycerol, propylene glycol, and 2-pyrrolidone.

These solvents slow down the evaporation of the composition with their excellent water retention potential, thereby enabling more stable ejection of droplets of the composition.

The lower limit to the nonaqueous solvent content of the aqueous ink jet composition is not critical, but preferably is 0% by mass, more preferably 3% by mass, even more preferably 5% by mass. The upper limit to the nonaqueous solvent content of the aqueous ink jet composition is not critical, but preferably is 30% by mass, more preferably 25% by mass, even more preferably 20% by mass.

This makes the aforementioned effects of the presence of a nonaqueous solvent more significant.

### Extra Ingredients

The aqueous ink jet composition may contain ingredients other than the particles, water, and nonaqueous solvents. Such ingredients may hereinafter be referred to as extra ingredients.

Examples of extra ingredients include colorants other than specific dyes; surfactants; dispersants; emulsifiers; penetrants, such as triethylene glycol monomethyl ether, triethylene glycol monobutyl ether, diethylene glycol monomethyl ether, 1,2-hexanediol, 1,2-pentanediol, 1,2-butanediol, and 3-methyl-1,5-pentanediol; drying retarders, such as triethanolamine; pH-adjusting agents; chelating agents, such as ethylenediaminetetraacetate; antimolds/preservatives; and antirusts. Compounds having an isothiazolinone structure in the molecule, for example, are suitable for use as antimolds/preservatives

In particular, the presence of a surfactant in the aqueous ink jet composition is advantageous in achieving better image quality. The surfactant will help improve the wettability of the aqueous ink jet composition on a recording medium.

A surfactant in the aqueous ink jet composition can be selected from various surfactants, including anionic surfactants, cationic surfactants, and nonionic surfactants.

More specifically, examples of surfactants that can be contained in the aqueous ink jet composition include acetylene surfactants, silicone surfactants, and fluorosurfactants.

The extra ingredient content of the aqueous ink jet composition is preferably 6% by mass or less, more preferably 5% by mass or less. When multiple extra ingredients are contained, it is preferred that the total amount satisfy this.

Besides the particles containing at least one specific dye and polyester, furthermore, the aqueous ink jet composition according to a preferred embodiment of the present disclosure may contain at least one of a specific dye and polyester not as a component of the particles.

When this is the case, the specific dye content of the aqueous ink jet composition excluding the specific dye in the particles is preferably 0.03% by mass or less, more preferably 0.02% by mass or less, even more preferably 0.01% by mass or less.

Likewise, the polyester content of the aqueous ink jet composition excluding the polyester in the particles is preferably 3% by mass or less, more preferably 2% by mass or less, even more preferably 1% by mass or less.

The lower limit to the surface tension at 25° C. of the aqueous ink jet composition is not critical, but preferably is 20 mN/m, more preferably 21 mN/m, even more preferably 23 mN/m. The upper limit to the surface tension at 25° C. of the aqueous ink jet composition is not critical, but preferably is 50 mN/m, more preferably 40 mN/m, even more preferably 30 mN/m.

This makes it less likely that, for example, the composition will clog the nozzles of an ink jet ejection apparatus used therewith, thereby further improving the stability of the aqueous ink jet composition upon ejection. The nozzles, moreover, will recover more quickly after capping even when clogged.

The surface tension can be that measured by the Wilhelmy method. The measurement of the surface tension can be through the use of a surface tensiometer, such as Kyowa Interface Science CBVP-7.

The lower limit to the viscosity at 25° C. of the aqueous ink jet composition is not critical, but preferably is 2 mPa·s, more preferably 3 mPa·s, even more preferably 4 mPa·s. The upper limit to the viscosity at 25° C. of the aqueous ink jet composition is not critical, but preferably is 30 mPa·s, more preferably 20 mPa·s, even more preferably 10 mPa·s.

This further improves the stability of the aqueous ink jet composition upon ejection.

The viscosity can be measured using a rheometer, such as Physica MCR-300. With such a rheometer, the shear rate is increased from 10 [s⁻¹] to 1000 [s⁻¹] at 25° C., and the viscosity is read at a shear rate of 200.

When the aqueous ink jet composition according to a preferred embodiment of the present disclosure is ink, the ink is usually packed in a container, such as a cartridge, bag, or tank, and used in that state with an ink jet recording apparatus. In other words, a recording apparatus according to a preferred embodiment of the present disclosure is one that includes an ink cartridge or other container in which ink as an aqueous ink jet composition according to a preferred embodiment has been packed.

### Method for Producing an Aqueous Ink Jet Composition

The following describes a method according to a preferred embodiment of the present disclosure for producing an aqueous ink jet composition.

A method according to a preferred embodiment of the present disclosure for producing an aqueous ink jet composition includes an emulsion preparation step, in which an emulsion is prepared by mixing a first composition and a second composition together, the first composition containing at least one specific dye, polyester, and at least one organic solvent and the second composition containing water, and thereby inducing phase inversion emulsification of the first composition; and an organic solvent removal step, in which at least part of the organic solvent is removed from the emulsion.

This is an efficient way to produce an aqueous ink jet composition having the aforementioned excellent characteristics.

First, a first composition is prepared. The first composition contains at least one specific dye, polyester, and at least one organic solvent.

The first composition may be prepared by mixing all of its ingredients at once or may be prepared by mixing its ingredients in two or more stages.

For example, it may be prepared by first mixing and kneading the polyester and the specific dye and then blending the resulting paste with the organic solvent to dissolve or disperse the polyester and specific dye therein.

An example of a suitable organic solvent is one whose solubility in water at 25° C. is 0.1 g/100 g H₂O or more and 30 g/100 g H₂O or less.

Examples of such organic solvents include ketones, such as methyl ethyl ketone and methyl isopropyl ketone; and esters, such as ethyl acetate and isopropyl acetate. One or a combination of two or more selected from these can be used.

Preferably, the organic solvent is one(s) in which the polyester dissolves or disperses and that can be easily removed later. Organic solvents having a relatively low boiling point are therefore preferred.

In these lights, the organic solvent is preferably methyl ethyl ketone and/or ethyl acetate, more preferably methyl ethyl ketone.

It should be noted that the first composition may be prepared with ingredients other than the specific dye, polyester, and organic solvent.

Examples of such ingredients include a basic component and an emulsifier.

### Emulsion Preparation Step

In the emulsion preparation step, an emulsion is prepared by mixing the first composition and a water-containing second composition together and thereby inducing phase inversion emulsification of the first composition.

An emulsion obtained in such a way is composed of an aqueous dispersion medium and a dispersoid containing at least one specific dye, polyester, and at least one organic solvent.

The second composition only needs to contain at least water. For example, the second composition may be purified water or may be a liquid that contains water and other ingredients.

An example of an ingredient other than water that can be contained in the second composition is a basic component.

A basic component in the second composition helps neutralize carboxyl groups of the polyester, thereby improving the hydrophilicity of the polyester.

The basic component may alternatively be mixed with the first composition before the mixing of the first and second compositions. Even in this case, the basic component has the same effects.

When a basic component is used, the lower limit to the amount of the basic component relative to the carboxyl groups of the polyester is preferably 0.6 equivalents. The upper limit to the amount of the basic component to the carboxyl groups of the polyester is preferably 3 equivalents, more preferably 2 equivalents, even more preferably 1.2 equivalents.

This helps hydrophilize the polyester better, thereby helping make the size distribution of the resulting particles sharper.

Examples of basic components include inorganic bases, such as sodium hydroxide, potassium hydroxide, and ammonia, and organic bases, such as diethylamine, triethylamine, and isopropylamine. One or a combination of two or more selected from these can be used.

The mixing of the first and second compositions may be through, for example, the addition of the second composition to the first composition or may be through the addition of the first composition to the second composition. Preferably, the first and second compositions are mixed together by adding the second composition to the first composition dropwise.

This enables better phase inversion emulsification of the first composition.

The mixing of the first and second compositions, moreover, is done preferably by adding the second composition to the first composition while stirring the first composition.

This enables better phase inversion emulsification of the first composition.

At the end of the emulsion preparation step, the lower limit to the percentage by mass of the organic solvent to the organic solvent plus water in the emulsion is preferably 20%, more preferably 23%. At the end of the emulsion preparation step, the upper limit to the percentage by mass of the organic solvent to the organic solvent plus water in the emulsion is preferably 35%, more preferably 30%.

### Organic Solvent Removal Step

In the organic solvent removal step, at least part of the organic solvent is removed from the emulsion.

As a result of this, solid particles containing a dye and polyester are formed. These particles correspond to the particles described above, a component of an aqueous ink jet composition according to a preferred embodiment of the present disclosure.

The organic solvent removal step can be done by, for example, heating the emulsion or placing the emulsion under reduced pressure conditions.

The organic solvent removal step gives a liquid dispersion composed of solid particles containing a dye and polyester and an aqueous dispersion medium in which the particles are dispersed. This liquid dispersion may be used directly as an aqueous ink jet composition according to a preferred embodiment of the present disclosure or may be mixed with other ingredients to give an aqueous ink jet composition according to a preferred embodiment of the present disclosure.

The organic solvent removal step may be followed by post-treatment, such as washing and drying.

This helps remove impurities, thereby making it more certain that the aqueous ink jet composition will be produced as designed.

The washing of the particles in the liquid dispersion obtained in the organic solvent removal step can be through, for example, isolation of the fine particles, in cake form, from the liquid dispersion using a separator, such as a centrifuge, filter press, or belt filter, addition of the cake of fine particles to water and dispersion by stirring, and subsequent dehydration.

After the dehydration, the particles may optionally be dried.

The drying can be through the use of, for example, a mixing vacuum dryer, such as a Ribocone dryer (Okawara Mfg.) or Nauta Mixer (Hosokawa Micron), or a dryer of fluidized bed type, such as a fluid bed dryer (Okawara Mfg.) or vibratory fluidized bed dryer (Chuo Kakohki).

When washing and drying are performed, mixing the washed particles with other ingredients including at least water gives an aqueous ink jet composition according to a preferred embodiment of the present disclosure as described above.

It should be noted that the organic solvent removal step only needs to remove at least part of the organic solvent in the emulsion, or more particularly that in the dispersoid in the emulsion, and does not need to remove the solvent completely. Even with partial removal in this step, the residual organic solvent can usually be removed to a sufficiently low concentration by post-treatment, such as washing and drying. In addition, small amounts of organic solvents are acceptable in the finished aqueous ink jet composition.

### Method for Producing a Recording

The following describes a method according to a preferred embodiment of the present disclosure for producing a recording.

A method according to a preferred embodiment of the present disclosure for producing a recording includes an attachment step, in which an aqueous ink jet composition according to a preferred embodiment of the present disclosure as described above is ejected by ink jet technology and attached to a recording medium; and a heating step, in which the recording medium with the aqueous ink jet composition attached thereto is heated.

The recording produced by this method is superior in color strength. Of particular note is that the color is strong with a wide variety of recording media.

### Attachment Step

In the attachment step, an aqueous ink jet composition is ejected by ink jet technology and attached to a recording medium. The ink jet ejection of the aqueous ink jet composition can be through the use of a known ink jet recording apparatus. Examples of ejection techniques include piezoelectric ejection and the use of bubbles resulting from heating ink. Piezoelectric ejection is particularly preferred, for example because it is less detrimental to the quality of the aqueous ink jet composition.

In the attachment step, multiple aqueous ink jet compositions according to a preferred embodiment of the present disclosure may be used in combination. More specifically, multiple aqueous ink jet compositions containing different kinds of specific dyes, for example, may be used in combination.

In the attachment step, moreover, it is possible to use inks other than the aqueous ink jet composition(s) according to a preferred embodiment of the present disclosure.

### Recording Medium

The recording medium can be made of any material or materials. Examples include resin materials, such as polyurethane, polyethylene, polypropylene, polyester, polyamide, and acrylic resin; paper, glass, metal, ceramic, leather, wood, and pottery clay and fiber of at least one of them; and natural, synthetic, or semisynthetic fibers, such as silk, wool, cotton, hemp (including similar plant-based fibers), polyester, polyamide (nylon), acrylic fiber, polyurethane, cellulose, linters, viscose rayon, cuprammonium rayon, and cellulose acetate, and one or a combination of two or more selected from these can be used. The recording medium can have any three-dimensional shape, such as a sheet, spherical, or cubic shape.

It is particularly preferred that the recording medium be a piece of fabric.

Fabric dyeing is in great demand, for example in the manufacture of printed T-shirts. Printing using an iron or similar tool is widespread, and there is a strong need for dyeing of fabrics other than polyester fiber fabric. Given these, the advantages of this preferred embodiment of the present disclosure are more significant when the recording medium is a piece of fabric.

Preferably, the recording medium is made of at least one material including one or two or more selected from the group consisting of silk, wool, cellulose, acrylic fiber, polyurethane, and polyamide.

Despite a strong need for dyeing of them, these materials have been unsuitable for dyeing with sublimation or disperse fluorescent dyes, for example because of their maximum withstand temperature. In this preferred embodiment of the present disclosure, a good recording can be produced even with a recording medium made with any of these materials. Given these, the advantages of this preferred embodiment of the present disclosure are more significant when the recording medium is made of at least one material including one or two or more selected from the group consisting of silk, wool, cellulose, acrylic fiber, polyurethane, and polyamide.

Fibers used in fabrics include hemp and animal-based fibers (e.g., wool). Being shaggy, hemp and animal-based fibers tend to interfere with ink ejection from nozzles by touching the ink jet head. Even if all nozzles successfully eject the ink, the ink does not adhere firmly because of many microscopic pores and irregularities present in the fabric. Hemp and animal-based fibers are therefore not appropriate for ink jet printing. Cotton, silk, polyester, polyamide, acrylic fiber, and polyurethane, which are not shaggy, are suitable for ink jet printing.

It is therefore preferred that the recording medium be made of at least one material including one or two or more selected from the group consisting of cotton, silk, polyester, polyamide, acrylic fiber, and polyurethane.

Certain recording media may be made of a mixture of polyester and any of these materials, i.e., made of materials including polyester and one or two or more selected from the group consisting of cotton, silk, polyamide, acrylic fiber, and polyurethane. With such a recording medium, known processes of dyeing with sublimation or disperse dye(s) have failed to dye the fiber(s) other than polyester, i.e., have tended to result in uneven dyeing. In this preferred embodiment of the present disclosure, even such a mixture dyes sufficiently well. The advantages of this preferred embodiment of the present disclosure are therefore more significant when the recording medium is such a mixture.

Even polyester alone, moreover, dyes better in this preferred embodiment of the present disclosure than in known processes of dyeing with sublimation or disperse dye(s) by virtue of highly efficient color production.

In the related art, a problem is that it is difficult to ensure sufficiently high color strength of the dye print and sufficiently firm adhesion between the recording medium and the dye print, and this problem looms larger when the recording medium is a piece of paper, glass, ceramic, metal, wood, or resin film or any other dense resin material, especially when the recording medium is a piece of glass. In this preferred embodiment of the present disclosure, the color strength of the dye print is sufficiently high, and the adhesion between the recording medium and the dye print is sufficiently firm even with any such recording medium. The advantages of the preferred embodiment of the present disclosure are therefore more significant when the recording medium is a piece of paper, glass, ceramic, metal, wood, or resin film or any other dense resin material.

### Heating Step

Then the recording medium with the aqueous ink jet composition attached thereto is heated. As a result, the specific dye is fixed to the recording medium together with the polyester and any other remaining ingredient. The specific dye produces its color well, giving a recording.

The lower limit to the heating temperature in this step is not critical, but preferably is 100° C., more preferably 105° C., even more preferably 110° C. The upper limit to the heating temperature in this step is not critical, but preferably is 160° C., more preferably 155° C., even more preferably 150° C.

This helps further reduce the amount of energy required to produce the recording, thereby helping further improve productivity in manufacturing recordings. The color strength of the resulting recording, moreover, will be further improved. Moreover, even recording media relatively vulnerable to heat are suitable for use, providing further flexibility in the selection of the recording medium. Furthermore, even when the produced recording is heated, for example by laundering or washing with warm water, heat drying in a dryer, or ironing, events like a unwanted discoloration and a change in optical density are well prevented.

The duration of heating in this step may vary with the heating temperature, but the lower limit to the duration of heating in this step is preferably 0.2 seconds, more preferably 1 second, even more preferably 5 seconds. The upper limit to the duration of heating in this step is preferably 300 seconds, more preferably 60 seconds, even more preferably 30 seconds.

This helps further reduce the amount of energy required to produce the recording, thereby helping further improve productivity in manufacturing recordings. The color strength of the resulting recording, moreover, will be further improved. Moreover, even recording media relatively vulnerable to heat are suitable for use, providing further flexibility in the selection of the recording medium.

This step may be performed by heating the surface of the recording medium to which the aqueous ink jet composition has been attached with this surface spaced apart from the heater or may be performed by heating this surface with the recording medium with the aqueous ink jet composition attached thereto and the heater in close contact with each other. Preferably, this step is performed by heating the surface of the recording medium to which the aqueous ink jet composition has been attached with the recording medium and the heater in close contact with each other.

This helps further reduce the amount of energy required to produce the recording, thereby helping further improve productivity in manufacturing recordings. The color strength of the resulting recording, moreover, will be further improved. Moreover, diffusion of the specific dye from the recording medium will be prevented more effectively.

It is to be understood that the foregoing is a description of preferred embodiments of the present disclosure, and no aspect of the present disclosure is limited to them.

For example, an aqueous ink jet composition according to a preferred embodiment of the present disclosure is to be ejected by ink jet technology, but its use is not limited to methods like that described above.

For example, the composition may be used in a method that includes extra operations besides the steps described above.

When this is the case, a pretreatment can be, for example, forming a coating layer on the recording medium.

An intermediate treatment can be, for example, preheating the recording medium.

A post-treatment can be, for example, washing the recording medium.

An aqueous ink jet composition according to a preferred embodiment of the present disclosure, moreover, may be used in a production method for a recording in which transfer is involved. In other words, the aqueous ink jet composition may be used in a method in which the composition is attached to an intermediate transfer medium, and then heat is applied to transfer the specific dye to the recording medium to be dyed by sublimation.

An aqueous ink jet composition according to a preferred embodiment of the present disclosure, furthermore, may be produced by any method and does not need be produced by the method described above. For example, in an aqueous ink jet composition according to a preferred embodiment of the present disclosure, the particles containing at least one specific dye and polyester may be those formed by emulsion polymerization. In another aqueous ink jet composition according to a preferred embodiment of the present disclosure, the particles containing at least one specific dye and polyester may be, for example, those produced through wet milling, dry milling, or any other type of milling of a paste obtained by kneading a mixture containing the specific dye and polyester.

### EXAMPLES

The following describes specific examples of aspects of the present disclosure.

### 1. Preparation of Ink Jet Inks

### Example 1

First, C.I. Disperse Yellow 54 as a specific dye was mixed with a self-emulsifying polyester having an acid value of 3 KOH mg/g, a hydroxyl value of 6 KOH mg/g, and a number-average molecular weight of 15×10³ according to predetermined proportions, and the resulting mixture was kneaded into a paste.

Then this paste was milled, and the product was mixed with methyl ethyl ketone as an organic solvent to give a first composition.

Then 1 N aqueous ammonia as a basic component was added to the first composition with stirring, and water was added dropwise to give an emulsion. The amount of the basic component was 1.0 equivalent relative to the carboxyl groups of the polyester. At the completion of the preparation of the emulsion, the percentage by mass of the organic solvent to the organic solvent plus water in the emulsion was 25%.

Then the emulsion was heated at 40° C. under reduced pressure for 120 minutes with stirring to make the organic solvent evaporate.

Then the liquid dispersion as the residue after the removal of the organic solvent was applied to a filter press to isolate the particles containing a specific dye and polyester as a cake of fine particles. This cake of fine particles was washed by adding it to water, dispersing it by stirring, and then removing water, and this washing process was repeated once again.

The washed cake of fine particles was then added to water and dispersed by stirring. Triethanolamine was added to give an aqueous dispersion of the particles. The particles obtained had a structure in which a specific dye had been dispersed in polyester.

Then the aqueous dispersion of particles were mixed with glycerol, triethylene glycol monobutyl ether, triethanolamine, OLFINE E1010 (Nissin Chemical Industry) as a surfactant, and purified water according to predetermined proportions, completing an ink jet ink as an aqueous ink jet composition.

The average particle diameter of C.I. Disperse Yellow 54 in the ink jet ink was 150 nm.

### Examples 2 to 5

An ink jet ink was produced as in Example 1 except that the specific dye was changed and the proportions of ingredients were adjusted according to the formula given in Table 1.

### Comparative Example 1

C.I. Disperse Red 364 as a specific dye, glycerol, triethylene glycol monobutyl ether, triethanolamine, OLFINE E1010 (Nissin Chemical Industry) as a surfactant, and purified water were mixed together according to the proportions specified in Table 1. The resulting mixture was slurried by stirring at 3000 rpm with a high-shear mixer (Silverson). The resulting slurry was stirred using a bead mill (LMZ015, Ashizawa Finetech) with 0.5-mm glass beads under water-cooled conditions to disperse the materials therein, completing an ink jet ink as an aqueous ink jet composition. The ink jet ink prepared in this Comparative Example therefore contained no polyester.

The average particle diameter of C.I. Disperse Red 364 in the ink jet ink was 150 nm.

### Comparative Example 2

C.I. Disperse Yellow 54 as a specific dye, a water-soluble polyester, glycerol, triethylene glycol monobutyl ether, triethanolamine, OLFINE E1010 (Nissin Chemical Industry) as a surfactant, and purified water were mixed together according to the proportions specified in Table 1. The resulting mixture was slurried by stirring at 3000 rpm with a high-shear mixer (Silverson). Then using a bead mill (LMZ015, Ashizawa Finetech), the resulting slurry was stirred with 0.5-mm glass beads under water-cooled conditions to disperse the materials therein, completing an ink jet ink as an aqueous ink jet composition. The aqueous ink jet composition in this Comparative Example contained dissolved polyester and no particles containing a specific dye and polyester.

The average particle diameter of C.I. Disperse Yellow 54 in the ink jet ink was 150 nm.

### Comparative Example 3

First, aqueous dispersion of particles were obtained as in Example 1 except that the paste was prepared without a specific dye.

Then the aqueous dispersion of particles were mixed with C.I. Disperse Yellow 54, glycerol, triethylene glycol monobutyl ether, triethanolamine, OLFINE E1010 (Nissin Chemical Industry) as a surfactant, and purified water according to predetermined proportions, completing an ink jet ink as an aqueous ink jet composition.

The average particle diameter of C.I. Disperse Yellow 54 in the ink jet ink was 150 nm.

### Comparative Example 4

An ink jet ink was produced as in Comparative Example 3 except that the specific dye was changed and the proportions of ingredients were adjusted according to the formula given in Table 1.

The makeup of the ink jet inks of Examples and Comparative Examples is summarized in Table 1. In the table, C.I. Disperse Yellow 54 is represented by “DY54,” C.I. Disperse Red 364 is represented by “DR364,” polyester is represented by “PEs,” glycerol is represented by “Gly,” triethylene glycol monobutyl ether is represented by “TEGBE,” triethanolamine is represented by “TEA,” and OLFINE E1010 (Nissin Chemical Industry) is represented by “E1010.” The ink jet inks of Examples 1 to 5 all had a surface tension of 25 mN/m or more and 35 mN/m or less. The surface tension was measured by the Wilhelmy method at 25° C. using a surface tensiometer (Kyowa Interface Science CBVP-7). The average diameter of the particles containing a specific dye and polyester in the ink jet ink was 100 nm or more and 300 nm or less in all Examples. The ink jet inks of Examples were also found to contain no specific dye or polyester outside the particles.

TABLE 1

| | Specific dye | | | | | | | | | | |
|---|---|---|---|---|---|---|---|---|---|---|---|
| | DY54 | DR364 | PEs | | Gly | TEGBE | TEA | E1010 | Water | Particles | PEs/ |
| | Amount | Amount | | Amount | Amount | Amount | Amount | Amount | Amount | containing | Specific dye |
| | [% by | [% by | | [% by | [% by | [% by | [% by | [% by | [% by | specific dye | [ratio by |
| | mass] | mass] | Type | mass] | mass] | mass] | mass] | mass] | mass] | and PEs present | weight] |
| Example 1 | 0.2 | 0 | Self-emulsifying | 4 | 10 | 3 | 1 | 0.5 | 81.3 | Yes | 20 |
| | | | PEs | | | | | | | | |
| Example 2 | 0 | 0.2 | Self-emulsifying | 10 | 10 | 3 | 1 | 0.5 | 75.3 | Yes | 50 |
| | | | PEs | | | | | | | | |
| Example 3 | 0.4 | 0 | Self-emulsifying | 20 | 10 | 3 | 1 | 0.5 | 65.1 | Yes | 50 |
| | | | PEs | | | | | | | | |
| Example 4 | 0 | 0.4 | Self-emulsifying | 30 | 10 | 3 | 1 | 0.5 | 55.1 | Yes | 75 |
| | | | PEs | | | | | | | | |
| Example 5 | 1.0 | 0 | Self-emulsifying | 5 | 10 | 3 | 1 | 0.5 | 79.5 | Yes | 5 |
| | | | PEs | | | | | | | | |
| Comparative | 0 | 0.4 | — | 0 | 10 | 3 | 1 | 0.5 | 85.1 | No | 0 |
| Example 1 | | | | | | | | | | | |
| Comparative | 0.4 | 0 | Water-soluble | 10 | 10 | 3 | 1 | 0.5 | 75.1 | No | 25 |
| Example 2 | | | PEs | | | | | | | | |
| Comparative | 0.4 | 0 | Self-emulsifying | 4 | 10 | 3 | 1 | 0.5 | 81.1 | No | 10 |
| Example 3 | | | PEs | | | | | | | | |
| Comparative | 0 | 0.4 | Self-emulsifying | 10 | 10 | 3 | 1 | 0.5 | 75.1 | No | 25 |
| Example 4 | | | PEs | | | | | | | | |

### 2. Testing

### 2-1 Viscosity

Each ink jet ink of Examples and Comparative Examples was subjected to viscosity measurement and graded according to the criteria below. The viscosity was measured using MCR-300 rheometer (Physica). With this rheometer, the shear rate was increased from 10 [s⁻¹] to 1000 [s⁻¹] at 25° C., and the viscosity was read at a shear rate of 200. An ink was considered good if the grade was B or better.

A: The viscosity is 2.0 mPa·s or more and less than 5.0 mPa·s.

B: The viscosity is 5.0 mPa·s or more and less than 10 mPa·s.

C: The viscosity is 10 mPa·s or more and less than 20 mPa·s.

D: The viscosity is 20 mPa·s or more and less than 30 mPa·s.

E: The viscosity is 30 mPa·s or more.

### 2-2 Color Strength

Each ink jet ink of Examples and Comparative Examples was ejected from PX-M860F recording apparatus (Seiko Epson) to draw a predetermined pattern on a piece of cotton fabric as a recoding medium.

Then the side of the recording medium onto which the ink jet ink had been attached was heated at 150° C. for 20 seconds using an iron as a heater, completing a recording.

The resulting recordings were graded for color strength. Specifically, in the production of each recording, chromaticity was measured between the attachment of ink jet ink and heating. The finished recording was also subjected to the measurement of chromaticity. The points of measurement were a point in the portion of the recording medium to which the ink jet ink had been attached and the same point of the finished recording, and the measuring instrument was i1 (X-rite). The results were used to determine the percentage increase after heating in saturation as measured in the L*a*b* color space (square root of (a*²+b*²)), and the optical density (OD) was also determined at a point of the recording to which the ink jet ink had been attached. Then color strength was graded according to the criteria below. Greater percentage increases in saturation and higher ODs mean better color strength. A recording was considered good if the grade was B or better.

A: The percentage increase in saturation is 50% or more, and the OD is 0.5 or more.

B: The percentage increase in saturation is 30% or more and less than 50%, and the OD is 0.5 or more.

C: The percentage increase in saturation is 15% or more and less than 30%, and the OD is 0.5 or more.

D: The percentage increase in saturation is 0% or more and less than 15%, and the OD is 0.5 or more.

E: Saturation is lower than before heating, or the OD is less than 0.5.

Then the same color strength test was repeated with different recording media: a piece of polyester fiber fabric, a piece of mixed fabric of polyester fiber and cotton fiber, a piece of silk fabric, a piece of polyurethane fabric, a piece of acrylic fiber fabric, and a piece of polyamide fiber fabric.

2-3 Color Strength with Transfer by Sublimation

Each ink jet ink of Examples and Comparative Examples was ejected from PX-M860F recording apparatus (Seiko Epson) to draw a predetermined pattern on a sheet of TRANSJET Classic (Cham Paper) as an intermediate transfer medium.

Then the side of the intermediate transfer medium to which the ink jet ink had been attached was attached firmly to a piece of polyester fabric as a recording medium. This workpiece was heated at 200° C. for 60 seconds using a heat press (TP-608M, Taiyoseiki) to initiate transfer by sublimation, completing a recording.

The resulting recordings were graded for color strength. Specifically, in the production of each recording, chromaticity was measured between the attachment of ink jet ink and heating. The finished recording was also subjected to the measurement of chromaticity. The points of measurement were a point in the portion of the recording medium to which the ink jet ink had been attached and the same point of the finished recording, and the measuring instrument was i1 (X-rite). The results were used to determine the percentage increase after heating in saturation as measured in the L*a*b* color space, and OD was also determined at a point of the recording to which the ink jet ink had been attached. Then color strength was graded according to the criteria below. Greater percentage increases in saturation and higher ODs mean better color strength. A recording was considered good if the grade was B or better.

A: The percentage increase in saturation is 50% or more, and the OD is 0.5 or more.

B: The percentage increase in saturation is 30% or more and less than 50%, and the OD is 0.5 or more.

C: The percentage increase in saturation is 15% or more and less than 30%, and the OD is 0.5 or more.

D: The percentage increase in saturation is 0% or more and less than 15%, and the OD is 0.5 or more.

E: Saturation is lower than before heating, or the OD is less than 0.5.

### 2-4 Fixation

Of the recordings of Examples and Comparative Examples produced in Section 2-2, those that were made using a piece of cotton fabric as a recording medium were washed with a laundry detergent (Lion TOP Clear Liquid) and warm water at 40° C. in a home washing machine (Toshiba Lifestyle Products & Services TW-Z9500L front-loader washing and drying machine) set to its standard mode. The percentage decrease in the OD of the dye print after washing was determined, and fixation was graded according to the criteria below. Smaller percentage decreases in OD mean better fixation of the dye print formed by the ink jet ink to the recording medium. A recording was considered good if the grade was B or better.

A: The percentage decrease in OD is less than 3%.

B: The percentage decrease in OD is 3% or more and less than 10%.

C: The percentage decrease in OD is 10% or more and less than 30%.

D: The percentage decrease in OD is 30% or more and less than 50%.

E: The percentage decrease in OD is 50% or more.

The results are summarized in Table 2.

TABLE 2

| | | Color strength | | | | | | | | |
|---|---|---|---|---|---|---|---|---|---|---|
| | | | | Polyester- | | | | | Color strength | |
| | | Cotton | Polyester | cotton mixed | Silk | Polyurethane | Acrylic | Polyamide | with transfer | |
| | Viscosity | fabric | fiber fabric | fabric | fabric | fabric | fiber fabric | fiber fabric | by sublimation | Fixation |
| Example 1 | A | A | A | A | A | A | A | A | A | B |
| Example 2 | A | A | A | A | A | A | A | A | A | A |
| Example 3 | B | A | A | A | A | A | A | A | A | A |
| Example 4 | B | A | A | A | A | A | A | A | A | A |
| Example 5 | A | B | A | B | B | B | B | B | A | B |
| Comparative | A | E | D | E | E | E | E | E | A | E |
| Example 1 | | | | | | | | | | |
| Comparative | C | C | B | C | C | C | C | C | A | C |
| Example 2 | | | | | | | | | | |
| Comparative | A | C | B | C | C | C | C | C | A | B |
| Example 3 | | | | | | | | | | |
| Comparative | A | C | B | C | C | C | C | C | A | B |
| Example 4 | | | | | | | | | | |

As is clear from Table 2, examples of aspects of the present disclosure achieved good results. In Comparative Examples, the results were unsatisfactory.

Another set of recordings were produced in the same way but with a sheet of cellulose paper as a recording medium, and the results were the same. Aqueous ink jet compositions and recordings were produced in the same way but with C.I. Disperse Red 60, C.I. Disperse Blue 360, or C.I. Disperse Yellow 232 as a specific dye, and the results were the same. Recordings were produced in the same way but with varying heating temperatures within the range of 100° C. to 160° C. and varying durations of heating within the range of 0.2 seconds to 300 seconds in the heating step, and the results were the same. Then recordings were produced as in Section 2-2 on a piece of cotton fabric, a piece of polyester fiber fabric, a piece of mixed fabric of polyester fiber and cotton fiber, a piece of silk fabric, a piece of polyurethane fabric, a piece of acrylic fiber fabric, and a piece of polyamide fiber fabric as a recording medium, except that the recording medium with ink jet ink attached thereto was heated at 200° C. for 60 seconds. In this case, the recordings were not evaluable. With silk fabric, the recording medium scorched when heated. With polyamide fiber, the recording medium melted when heated.

What is claimed is:

1. An aqueous ink jet composition comprising:
water; and
particles of a material containing polyester and a dye composed of at least one of sublimation dyes or at least one of disperse dyes.

2. The aqueous ink jet composition according to claim 1, wherein the dye is dispersed in the particles.

3. The aqueous ink jet composition according to claim 1, wherein 4≤X_{P}/X_{D≤}300, where X_{D} is a percentage of the dye in the particles in % by mass, and X_{P} is a percentage of the polyester in the particles in % by mass.

4. The aqueous ink jet composition according to claim 1, wherein an average diameter of the particles is 100 nm or more and 300 nm or less.

5. The aqueous ink jet composition according to claim 1, wherein the dye is C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, or C.I. Disperse Yellow 232.

6. The aqueous ink jet composition according to claim 1, wherein the polyester is a self-emulsifying polyester.

7. A method for producing an aqueous ink jet composition, the method comprising:
an emulsion preparation step, in which an emulsion is prepared by mixing a first composition and a second composition together, the first composition containing polyester, an organic solvent, and a dye composed of at least one of sublimation dyes or at least one of disperse dyes and the second composition containing water, and thereby inducing phase inversion emulsification of the first composition; and
an organic solvent removal step, in which at least part of the organic solvent is removed from the emulsion.

8. A method for producing a recording, the method comprising:
an attachment step, in which an aqueous ink jet composition according to claim 1 is ejected by ink jet technology and attached to a recording medium; and
a heating step, in which the recording medium with the aqueous ink jet composition attached thereto is heated.

9. The method according to claim 8 for producing a recording, wherein the recording medium is a piece of fabric.

10. The method according to claim 8 for producing a recording, wherein the recording medium is made of at least one material including one or two or more selected from the group consisting of silk, wool, cellulose, acrylic fiber, polyurethane, and polyamide.

11. The method according to claim 8 for producing a recording, wherein the recording medium is made of materials including polyester and one or two or more selected from the group consisting of cotton, silk, polyamide, acrylic fiber, and polyurethane.

12. The method according to claim 8 for producing a recording, wherein a temperature at which the recording medium is heated in the heating step is 100° C. or more and 160° C. or less.
